(19) United States
(12) Patent Application Publication
(10) Pub. No.: US 2010/0070932 A1
(43) Pub. Date: Mar. 18, 2010

(54) VEHICLE ON-BOARD DEVICE

(75) Inventor: Christopher HUR, Northville, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 12/233,024

(22) Filed: Sep. 18, 2008

(51) Int. Cl. G06F 3/033

(52) U.S. Cl. 715/863

(57) ABSTRACT

A vehicle on-board device includes a user interface device and a processing section. The user interface device is mounted inside of a vehicle, and configured and arranged to output information to a user and to receive a user input. The processing section is operatively coupled to the user interface device, and configured to perform a prescribed function in response to a prescribed user operation received by the user input interface device. The processing section is further configured to perform an interactive tutorial control to provide the user with at least one interactive instruction for the prescribed function in which the processing section prompts the user to input the prescribed user operation, determines whether the user input received by the user interface device matches the prescribed user operation, and completes the interactive learning control when the user input matches the prescribed user operation.

### BACKGROUND OF THE INVENTION

1. Field of the Invention

The present invention relates to a vehicle on-board device. More specifically, the present invention relates to a vehicle on-board device configured and arranged to provide a user with step-by-step interactive instructions for a prescribed function performed by the vehicle on-board device.

2. Background Information

Recently, vehicles are being equipped with a vehicle on-board device encompassing a variety of informational systems such as navigation systems, Sirius and XM satellite radio systems, two-way satellite services, built-in cell phones, audio players, DVD players and the like. These systems are sometimes interconnected for increased functionality. However, the operations of these various information systems could be so complex that it is sometimes difficult for the user to figure out how these systems function, or to remember specific operations of these systems. One solution for such a problem is to read the owner's manual of these information systems. However, the owner's manual may not always be reasonably accessible to the user when the user needs the information written in the owner's manual. Moreover, the owner's manuals usually consist of hundreds of pages, and thus, it may be troublesome for the user to search through hundreds of pages to find the exact information the user wishes to read.

In view of the above, it will be apparent to those skilled in the art from this disclosure that there exists a need for an improved vehicle on-board device that allows the user of the vehicle on-board unit to learn functions and/or operations of various systems in a relatively convenient manner. This invention addresses this need in the art as well as other needs, which will become apparent to those skilled in the art from this disclosure.

### SUMMARY OF THE INVENTION

One object is to provide a vehicle on-board device that provides a user with step-by-step interactive instructions for a prescribed function performed by the vehicle on-board device by using an existing user interface device.

In order to achieve this object, a vehicle on-board device includes a user interface device and a processing section. The user interface device is mounted inside of a vehicle, and configured and arranged to output information to a user and to receive a user input. The processing section is operatively coupled to the user interface device, and configured to perform a prescribed function in response to a prescribed user operation received by the user input interface device. The processing section is further configured to perform an interactive tutorial control to provide the user with at least one interactive instruction for the prescribed function in which the processing section prompts the user to input the prescribed user operation, determines whether the user input received by the user interface device matches the prescribed user operation, and completes the interactive learning control when the user input matches the prescribed user operation.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a diagrammatic illustration of an interior of a vehicle equipped with a vehicle on-board device in accordance with an illustrated embodiment;

FIG. 2 is a block diagram showing a control system for the vehicle on-board device in accordance with the illustrated embodiment;

FIG. 3 is a simplified view of a display device of the vehicle on-board device illustrating an example of an information menu screen in accordance with the illustrated embodiment;

FIG. 4 is a simplified view of the display device of the vehicle on-board device illustrating an example of a display screen, in which a user selects an interactive training mode for a navigation system in accordance with the illustrated embodiment;

FIG. 5 is a simplified view of the display device of the vehicle on-board device illustrating an example of a display screen, in which the user selects the interactive training mode for a voice recognition function in accordance with the illustrated embodiment;

FIG. 6 is a simplified view of the display device of the vehicle on-board device illustrating an example of a display screen, in which the user selects the interactive training mode for a destination street address operation in accordance with the illustrated embodiment;

FIG. 7 is a flowchart for explaining a control flow of an interactive tutorial control executed by the vehicle on-board device when the user selects the destination street address operation using the voice recognition function in accordance with the illustrated embodiment;

FIG. 8 is a simplified view of the display device of the vehicle on-board device illustrating an example of a display screen for showing a location of a talk switch of vehicle on-board device in accordance with the illustrated embodiment;

FIG. 9 is a simplified view of the display device of the vehicle on-board device illustrating an example of a display screen for showing a location of a back button of vehicle on-board device in accordance with the illustrated embodiment;

FIG. 10 is a simplified view of the display device of the vehicle on-board device illustrating an example of a display screen, in which the user is prompted to locate the talk switch in accordance with the illustrated embodiment;

FIG. 11 is a simplified view of the display device of the vehicle on-board device illustrating an example of a display screen, in which the user fails to correctly locate the talk switch in accordance with the illustrated embodiment;

FIG. 12 is a simplified view of the display device of the vehicle on-board device illustrating an example of a display screen, in which the user is prompted to locate the back button in accordance with the illustrated embodiment;

FIG. 13 is a simplified view of the display device of the vehicle on-board device illustrating an example of a display screen, in which the user correctly locates the back button in accordance with the illustrated embodiment;

FIG. 14 is a simplified view of the display device of the vehicle on-board device illustrating an example of a display screen, in which the user is prompted to input a voice command for entering a destination street address in accordance with the illustrated embodiment;

FIG. 15 is a simplified view of the display device of the vehicle on-board device illustrating an example of a display screen, in which the user is prompted to input a name of the destination state in accordance with the illustrated embodiment;

FIG. 16 is a simplified view of the display device of the vehicle on-board device illustrating an example of a display screen, in which the system notifies the user that the user did not correctly input the name of the destination state in accordance with the illustrated embodiment;

FIG. 17 is a simplified view of the display device of the vehicle on-board device illustrating an example of a display screen, in which the user is prompted to input a name of the destination city in accordance with the illustrated embodiment;

FIG. 18 is a simplified view of the display device of the vehicle on-board device illustrating an example of a display screen, in which the user is prompted to input a name of the destination street in accordance with the illustrated embodiment;

FIG. 19 is a simplified view of the display device of the vehicle on-board device illustrating an example of a display screen, in which the user is prompted to input a name of the destination house number in accordance with the illustrated embodiment;

FIG. 20 is a simplified view of the display device of the vehicle on-board device illustrating an example of a display screen, in which the user is prompted to input a voice command for calculating route in accordance with the illustrated embodiment; and

FIG. 21 is a simplified view of the display device of the vehicle on-board device illustrating an example of a display screen, in which the system completes the interactive training mode after calculating the route to the specified street address destination in accordance with the illustrated embodiment.

### DETAILED DESCRIPTION OF THE PREFERRED EMBODIMENTS

Selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

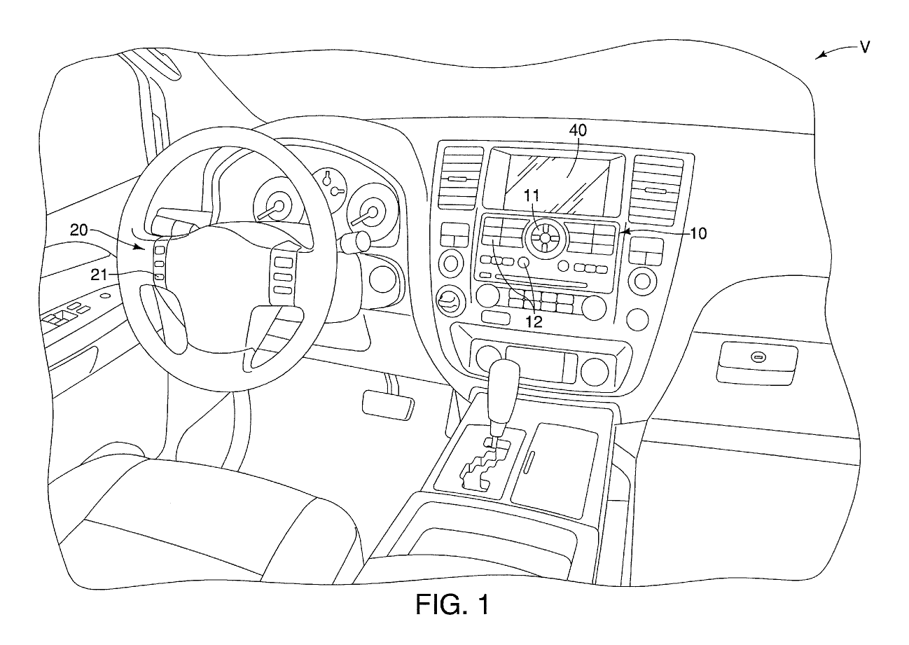

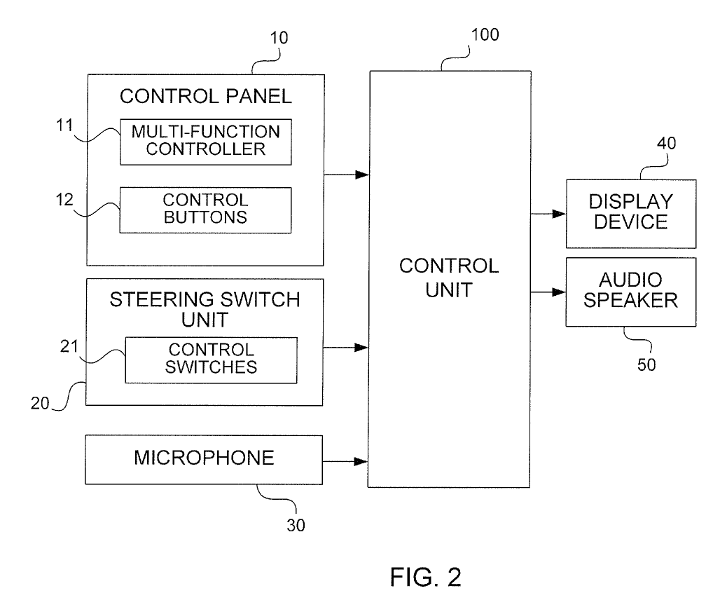

Referring initially to FIGS. 1 and 2, a vehicle on-board device is illustrated in accordance with an illustrated embodiment. As shown in FIGS. 1 and 2, the vehicle on-board device of the illustrated embodiment has a user interface device mounted inside of a vehicle V with the user interface device including a control panel 10, a steering switch unit 20, a microphone 30 (shown only in FIG. 2), a display device 40 and an audio speaker 50 (shown only in FIG. 2). The control panel 10, the steering switch unit 20, the microphone 30, the display device 40 and the audio speaker 50 are operatively coupled to a control unit 100 (shown only in FIG. 2) of the vehicle on-board unit in a conventional manner. The control panel 10, the steering switch unit 20, the microphone 30 preferably constitute the user input interface through which a user of the vehicle on-board device enters user input operations, which are sent to the control unit 100. The display device 40 and the audio speaker 50 preferably constitute the user output interface through which the information outputted from the control unit 100 is presented to the user. The control unit 100 is configured and arranged to control a plurality of prescribed functions of the vehicle on-board device including, but not limited to, navigation control, display control, audio control, climate control and phone control in a conventional manner. In addition, with the vehicle on-board unit according to the illustrated embodiment, the control unit 100 is further configured and arranged to execute an interactive tutorial control to provide the user with step-by-step interactive instructions for using these prescribed functions of the vehicle on-board device.

The control unit 100 preferably includes a microcomputer with an interactive tutorial control program that controls the vehicle on-board unit as discussed below. The control unit 100 also includes other conventional components such as an input interface circuit, an output interface circuit, and storage devices such as a ROM (Read Only Memory) device, a RAM (Random Access Memory) device and HDD (Hard Disc Drive). Preferably, the interactive programs are stored in the HDD. The microcomputer of the control unit 100 is programmed to control the display device 40 and the audio speaker 50. The control unit 100 is operatively coupled to the control panel 10, the steering switch unit 20, the microphone 30, the display device 40 and the audio speaker 50 in a conventional manner. The internal RAM of the control unit 100 stores statuses of operational flags and various control data. The internal ROM of the control unit 100 stores data for various operations. The control unit 100 is capable of selectively controlling any of the components of the control system of the vehicle on-board device in accordance with the control program. It will be apparent to those skilled in the art from this disclosure that the precise structure for the control unit 100 can be any combination of hardware and software that will carry out the functions of the illustrated embodiment.

As shown in FIG. 1, the control panel 10 is disposed in a center portion of an instrument panel of the vehicle V. The control panel 10 preferably includes a multi-function controller 11 and a plurality of control buttons 12. The multi-function controller 11 of the control panel 10 is configured and arranged to highlight an item in a screen displayed on the display device 40, to select the highlighted item, and to move on the map. The multi-function controller 11 includes, for example, direction buttons and a center dial for moving across the map to highlight an item on the screen, and an enter button for selecting the highlighted item on the screen. The control buttons 12 of the control panel 10 are configured and arranged to be used to operate various components and functions of the vehicle V. The control buttons 12 can include, but not limited to, a status button for displaying the current status of various vehicle systems (e.g., the air conditioner, radio, audio, vehicle information and navigation system), a destination button for entering a destination in the navigation system, a route button for accessing guidance control functions, an information button for displaying the vehicle information and the navigation information (e.g., GPS or version information), a day/night off button for switching between the day screen (bright) and the night screen (dark), a setting button for accessing the system setting, a voice button for repeating voice guidance for a guide point, a back button for returning to the previous screen, a map button for displaying the current location map screen, zoom in/zoom out buttons for switching to the zoom mode to change the map scale.

As shown in FIG. 1, the steering switch unit 20 is disposed on a steering wheel of the vehicle V. The steering switch unit 20 includes a plurality of control switches 21. The control switches 21 of the steering switch unit 20 can include, but not limited to a volume switch for adjusting the volume of the audio speaker 50, a talk switch for starting the voice recognition mode, a tuning switch for operating the audio system, a mode switch for ending a call when the vehicle on-board system is operating in the phone mode.

The microphone 30, the display device 40 and the audio speaker 50 are conventional components that are well known in the art. Since the display device 40 and the audio speaker 50 are well known in the art, these structures will not be discussed or illustrated in detail herein. Rather, it will be apparent to those skilled in the art from this disclosure that the components can be any type of structure and/or programming that can be used to carry out the illustrated embodiment.

The vehicle on-board device of the illustrated embodiment is configured and arranged to perform a plurality of conventional functions, for example, the navigation control, display control, audio control, climate control and phone control. Moreover, the vehicle on-board device of the illustrated embodiment executes an interactive tutorial control for the user so that the user can learn how to use these functions of the vehicle on-board device by using the existing user interface device (e.g., the control panel 10, the steering switch unit 20, the microphone 30, the display device 40 and the audio speaker 50). For example, the vehicle on-board device of the illustrated embodiment can be configured and arranged to provide the user with the interactive tutorial on how to use technologies such as Bluetooth hands-free functions, a voice destination entry (voice recognition) function, a manual destination entry function, a point-of-interest search function, an audio control function, etc. that are performed by the vehicle on-board device.

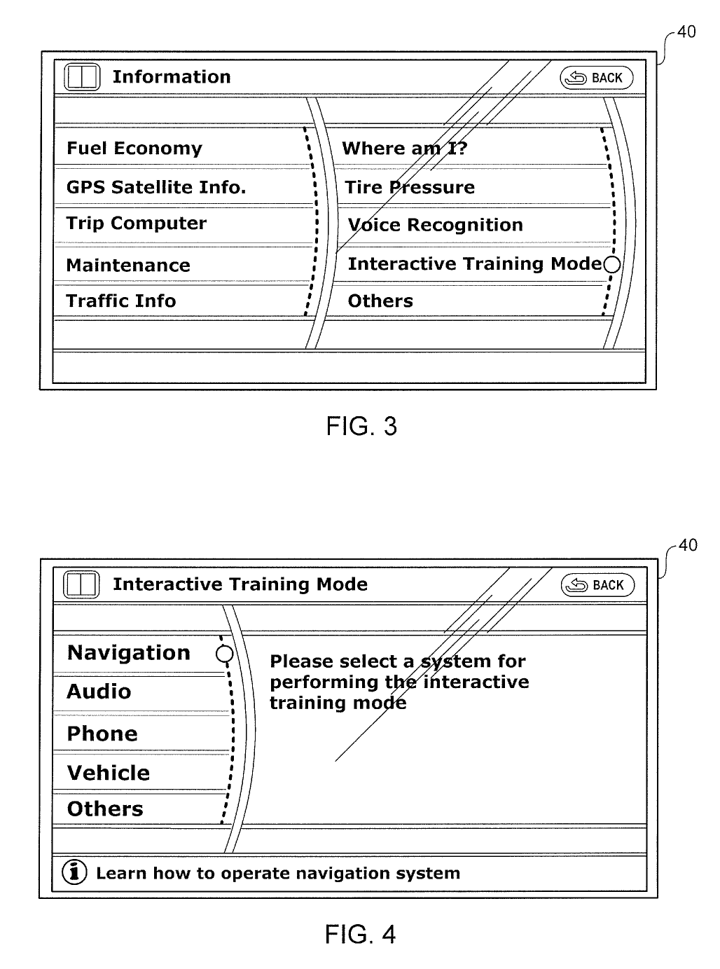

Referring now to FIGS. 3 to 21, the interactive tutorial control executed by the control unit 100 of the vehicle on-board device will be explained in accordance with the illustrated embodiment. In the following description, the interactive tutorial control for learning the voice destination entry (voice recognition) function of the vehicle on-board unit will be used as an example for explaining the interactive tutorial control according to the illustrated embodiment. However, it will be apparent to those skilled in the art from this disclosure that the interactive tutorial control performed by the vehicle on-board device of the illustrated embodiment is not limited to the interactive tutorial control for the voice destination entry function. Rather, the interactive tutorial control of the illustrated embodiment can be applied to operations of any functions performed by the vehicle on-board device including, but not limited to, the navigation control, display control, audio control, climate control and phone control.

First, in order to start the interactive tutorial control, the user of the vehicle on-board device displays an information menu screen by, for example, pressing the information button located on the control panel 10. FIG. 3 shows an example of the information menu screen that appears on the display device 40 when the user pushes the information button. As shown in FIG. 3, the information menu preferably includes an option for the interactive training mode.

When the user selects the interactive training mode by operating the user input interface (e.g., by operating the multi-function controller 11 in the control panel 10), the control unit 100 is preferably configured to show a list of the systems for which the interactive training is available. For example, FIG. 4 shows an example of a display screen for prompting the user to select one of the options (e.g., the navigation system, the audio system, the phone system, the vehicle system, and others) for which the interactive training is provided. In this example, the user selects the interactive training for the navigation system.

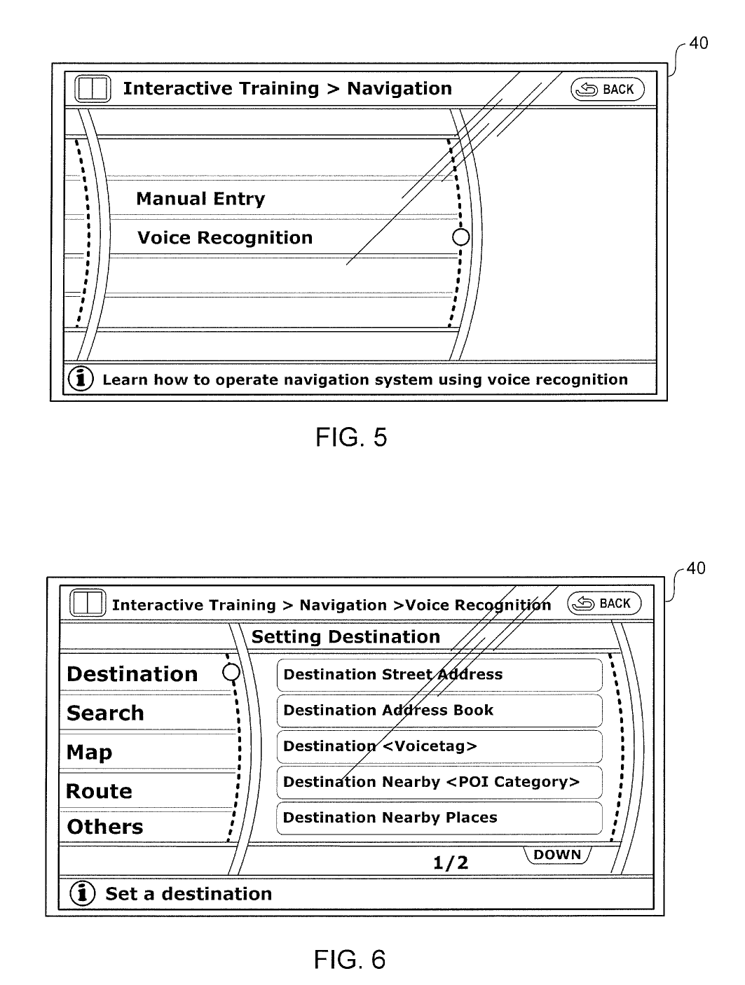

Then, the control unit 100 is preferably configured to prompt the user to select one of the manual entry and the voice recognition as an input method for the navigation operations. FIG. 5 shows an example of a display screen for prompting the user to select one of the manual entry and the voice recognition for which the interactive training is provided. In this example, the user selects the interactive training for the voice recognition function.

Next, the user is further provided with an option to choose one of the navigation operations performed by using the voice recognition function. FIG. 6 shows an example of a display screen for prompting the user to select one of the navigation operations (e.g., destination entry, search, map operation, route setting, and others) for which the interactive training is performed. In this example, the user selects the destination street address operation to enter a location specified by the street address by using the voice recognition function. Then, the control unit 100 is configured to start the interactive tutorial control for the destination street address operation using the voice recognition function.

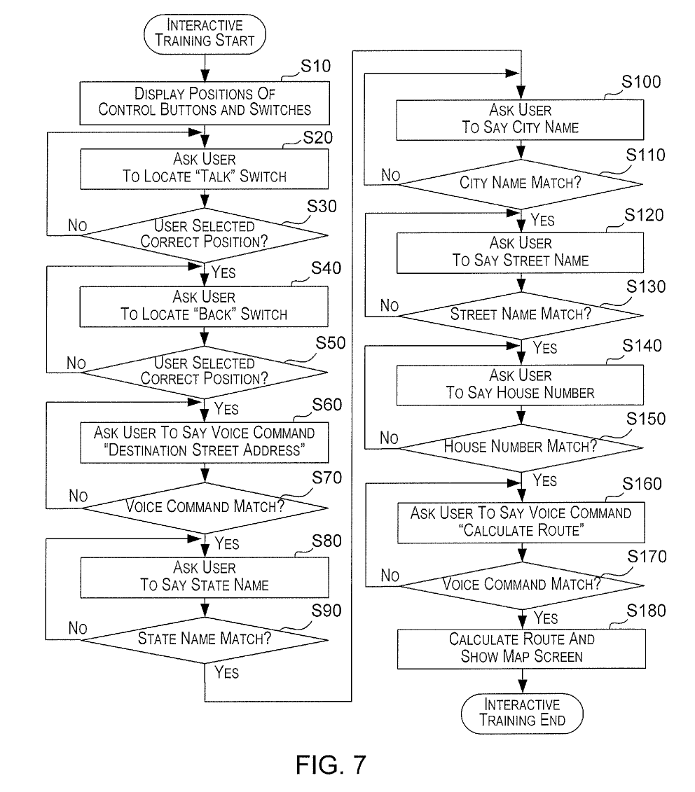

FIG. 7 is a flowchart for explaining a control flow executed by the control unit 100 to execute the interactive tutorial control for the destination street address operation using the voice recognition function according to the illustrated embodiment.

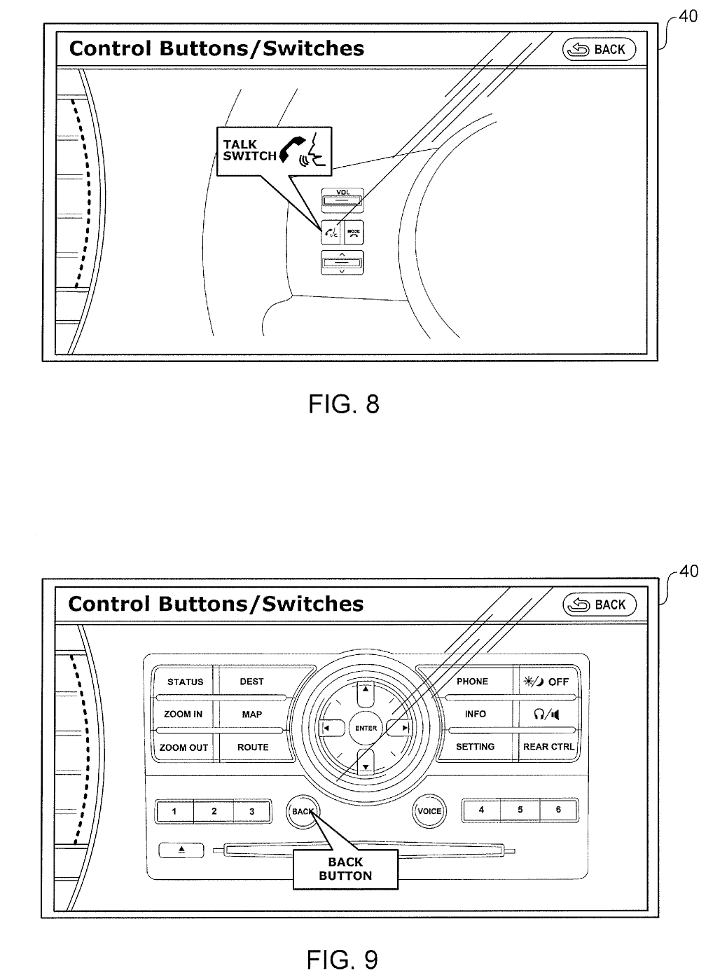

Initially, in step S10, the control unit 100 is configured to provide a graphic display (e.g., photographic image, video image, illustration, animation, etc.) on the display device 40 to show the control switches/buttons that are likely to be operated by the user during the destination street address operation using the voice recognition function. In this example, the control unit 100 is configured to display locations of the talk switch (one of the control switches 21) of the steering switch unit 20 and the back button (one of the control buttons 12) of the control panel 10. FIGS. 8 and 9 show examples of the graphic display on the display device 40 for showing the locations of the talk switch and the back button for the user. The control unit 100 can be further configured to provide brief explanation of the functions of the control buttons and switches for the user by using the user output interface device (e.g., the display device 40 and/or the audio speaker 50).

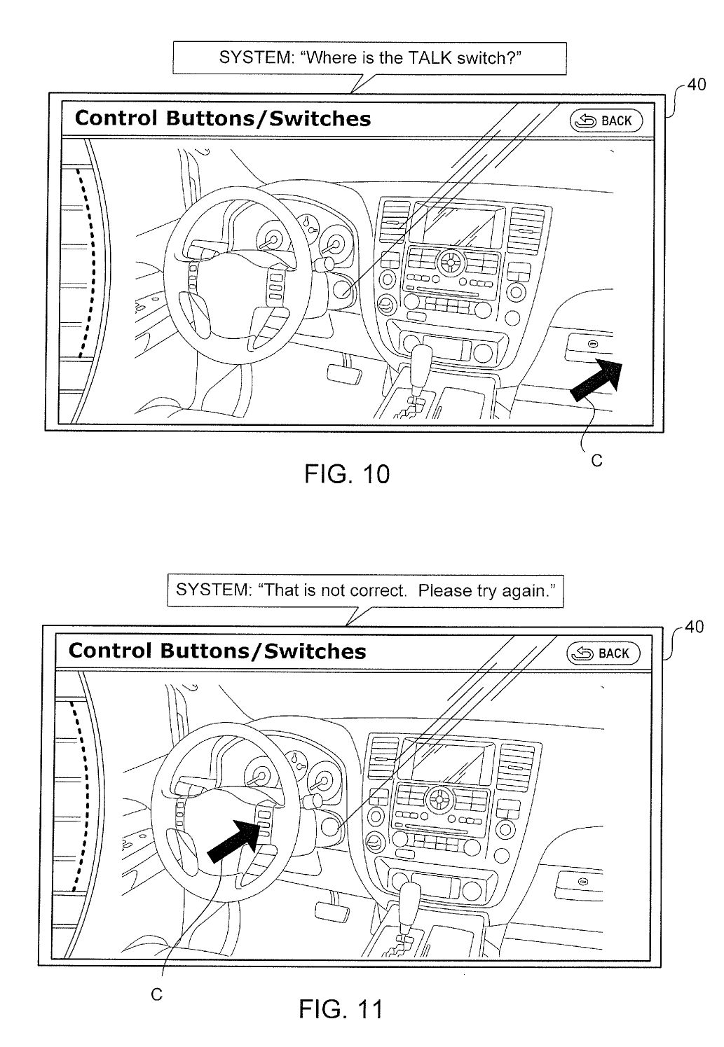

Then, in step S20, the control unit 100 is configured to ask the user to locate the talk switch in the display screen on the display device 40 in order to ensure that the user understands where the talk switch is located. FIG. 10 shows an example of the display screen and audio output when the control unit 100 prompts the user to locate the talk switch in the display screen on the display device 40. The vehicle on-board device can be configured and arranged such that the user moves a cursor C or the like displayed on the display device 40 by operating the multi-function controller 11 to point at a location corresponding to the talk switch and presses the enter button to confirm the position of the cursor C. Alternatively, the vehicle on-board device can be configured and arranged such that the control unit 100 asks the user to actually press the talk switch located on the steering switch unit 20 to ensure that the user understands the location of the talk switch.

In step S30, the control unit 100 is configured to determine whether the user has selected a correct location of the talk switch on the display screen. If the control unit 100 determines that the user has not selected the correct location of the talk switch, then the control unit 100 is configured to inform the user that the location selected by the user is not correct. Then, the control unit 100 is configured to return to step S20 and ask the user to locate the talk switch again. FIG. 11 shows an example of the display screen and audio output in which the user has selected a wrong location and the control unit 100 prompts the user to locate the talk switch again. On the other hand, if the control unit 100 determines that the user has selected the correct location of the talk switch in step S30, then the control unit 100 is configured to inform the user that the location selected by the user is correct. The control unit 100 then proceeds to step S40.

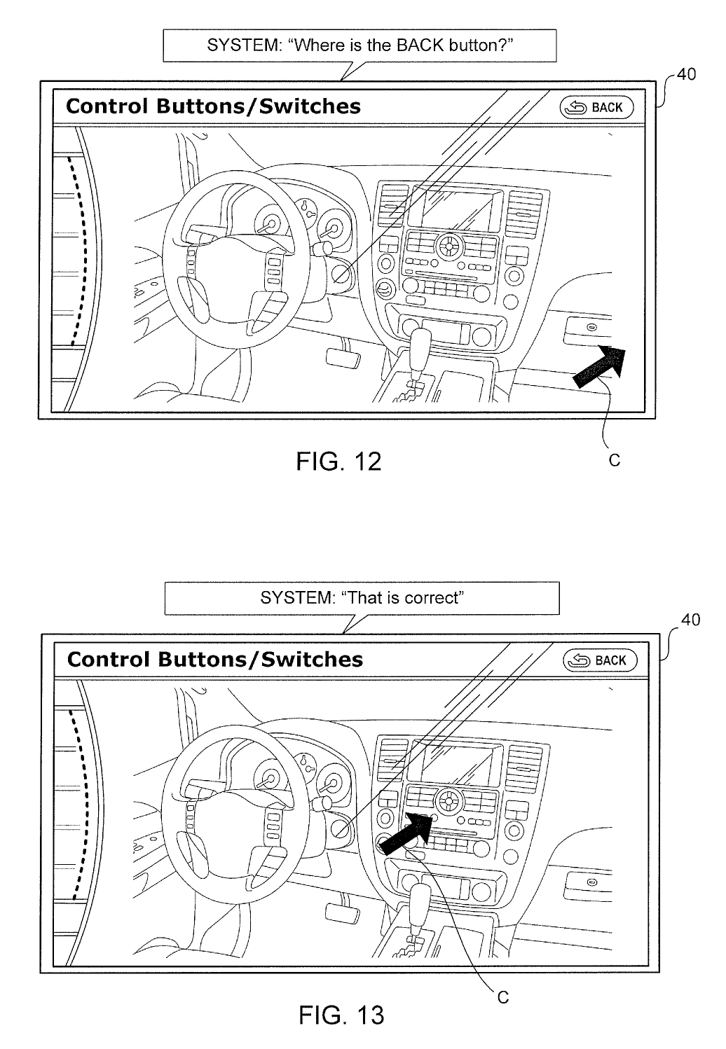

In step S40, the control unit 100 is configured to ask the user to locate the back button in the display screen on the display device 40 in order to ensure that the user understands the location of the back button. FIG. 12 shows an example of the display screen and audio output when the control unit 100 prompts the user to locate the back button in the display screen on the display device 40.

In step S50, the control unit 100 is configured to determine whether the user has selected a correct location of the back button. If the control unit 100 determines that the user has not selected the correct location of the back button, then the control unit 100 is configured to inform the user that the location selected by the user is not correct. Then, the control unit 100 is configured to return to step S40 and ask the user to locate the back button again. On the other hand, if the control unit 100 determines that the user has selected the correct location of the back button in step S50, then the control unit 100 is configured to inform the user that the location selected by the user is correct. FIG. 13 shows an example of the display screen and audio output in which the user has selected a correct location of the back button. The control unit 100 then proceeds to step S60.

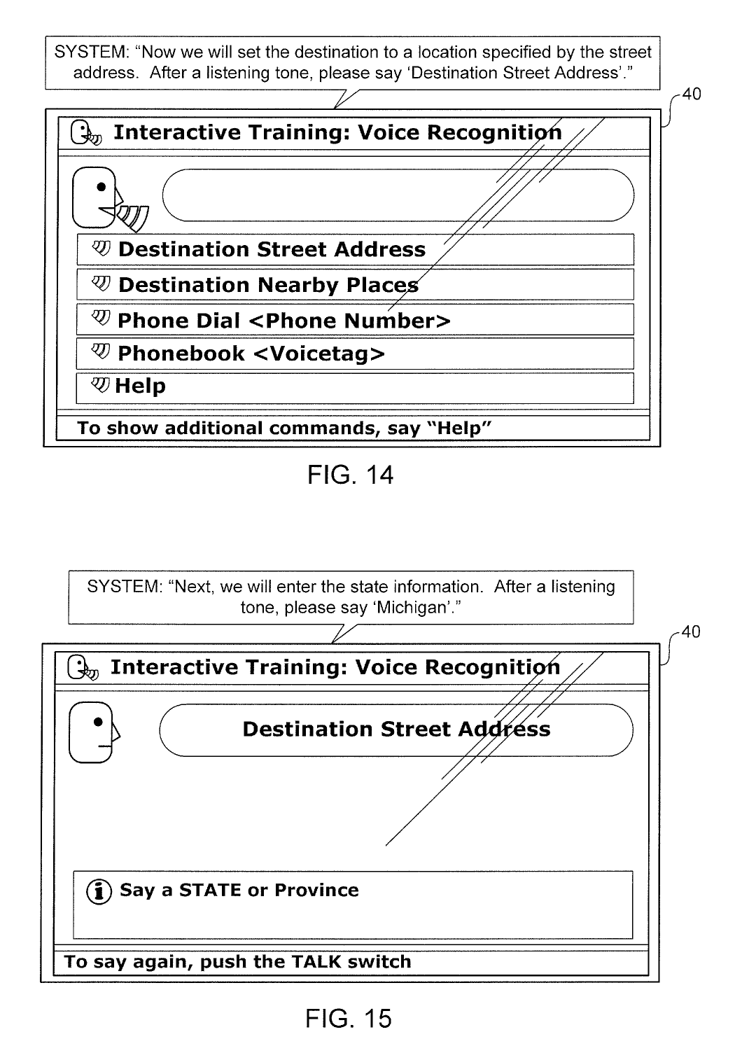

In step S60, the control unit 100 is configured to present an initial display screen for the destination street address operation on the display device 40. FIG. 14 is an example of the initial display screen and audio output for the destination street address operation. Then, the control unit 100 is configured to prompt the user to input a reference voice command “Destination Street Address” by issuing a voice prompt (e.g., “Now we will set a destination to a location specified by the street address. After a listening tone, please say ‘Destination Street Address’.”). Of course, it will be apparent to those skilled in the art from this disclosure that the control unit 100 can be configured to issue a visual prompt (e.g., text) on the display device 40 instead of or in addition to the voice prompt. At this point, the control unit 100 is configured to start the voice recognition function and to open the microphone 30.

In step S70, the control unit 100 is configured to determine whether the voice recognition command inputted by the user through the microphone 30 matches the reference voice command (“Destination Street Address” in this example). More specifically, the control unit 100 is configured to convert the acoustic sound captured by the microphone 30 to the machine readable input, and then to compare the input with the stored reference values that correspond to the reference voice command “Destination Street Address”. The voice recognition or speech recognition function is well known in the art. Since the voice recognition or speech recognition function is well known in the art, the operations of the voice recognition or speech recognition function will not be discussed or illustrated in detail herein. Rather, it will be apparent to those skilled in the art from this disclosure that the voice recognition or speech recognition function can utilize any method and/or programming that can be used to carry out the illustrated embodiment. If the control unit 100 determines that the user's input does not match the reference voice command, then the control unit 100 returns to step S60 to ask the user to input the voice command again. On the other hand, if the control unit 100 determines that the user's input matches the reference voice command, then the control unit 100 proceeds to step S80. The control processing in steps S60 and S70 is repeated until the user's input matches the reference voice command.

In step S80, the control unit 100 is configured to prompt the user to input the reference state name “Michigan” by issuing a voice prompt (e.g., “Next, we will enter the state information. After a listening tone, please say the state name ‘Michigan’.”). FIG. 15 is an example of the display screen and audio output for prompting the user to input the state name.

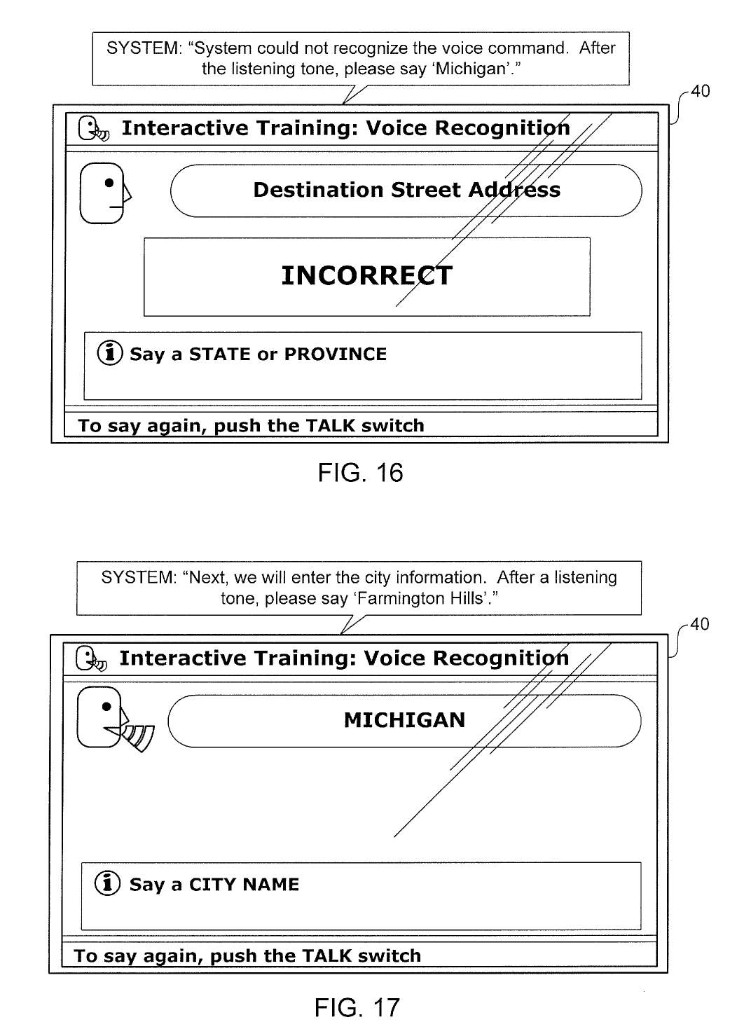

In step S90, the control unit 100 is configured to determine whether the state name inputted by the user through the microphone 30 matches the reference state name (“Michigan” in this example). If the control unit 100 determines that the user's input does not match the reference state name, then the control unit 100 returns to step S80 to ask the user to input the state name again. FIG. 16 shows an example of a display screen and audio output for informing the user that the user's input does not match the reference state name. The control processing in steps S80 and S90 is repeated until the user's input matches the reference state name. On the other hand, if the control unit 100 determines that the user's input matches the reference state name, then the control unit 100 proceeds to step S100.

In step S100, the control unit 100 is configured to prompt the user to input the reference city name “Farmington Hills” by issuing a voice prompt (e.g., “Next, we will enter the city information. After a listening tone, please say the city name ‘Farmington Hills’.”). FIG. 17 is an example of the display screen and audio output for prompting the user to input the city name.

In step S110, the control unit 100 is configured to determine whether the city name inputted by the user through the microphone 30 matches the reference city name (“Farmington Hills” in this example). If the control unit 100 determines that the user's input does not match the reference city name, then the control unit 100 returns to step S100 to ask the user to input the city name again. The control processing in steps S100 and S110 is repeated until the user's input matches the reference city name. On the other hand, if the control unit 100 determines that the user's input matches the reference city name, then the control unit 100 proceeds to step S120.

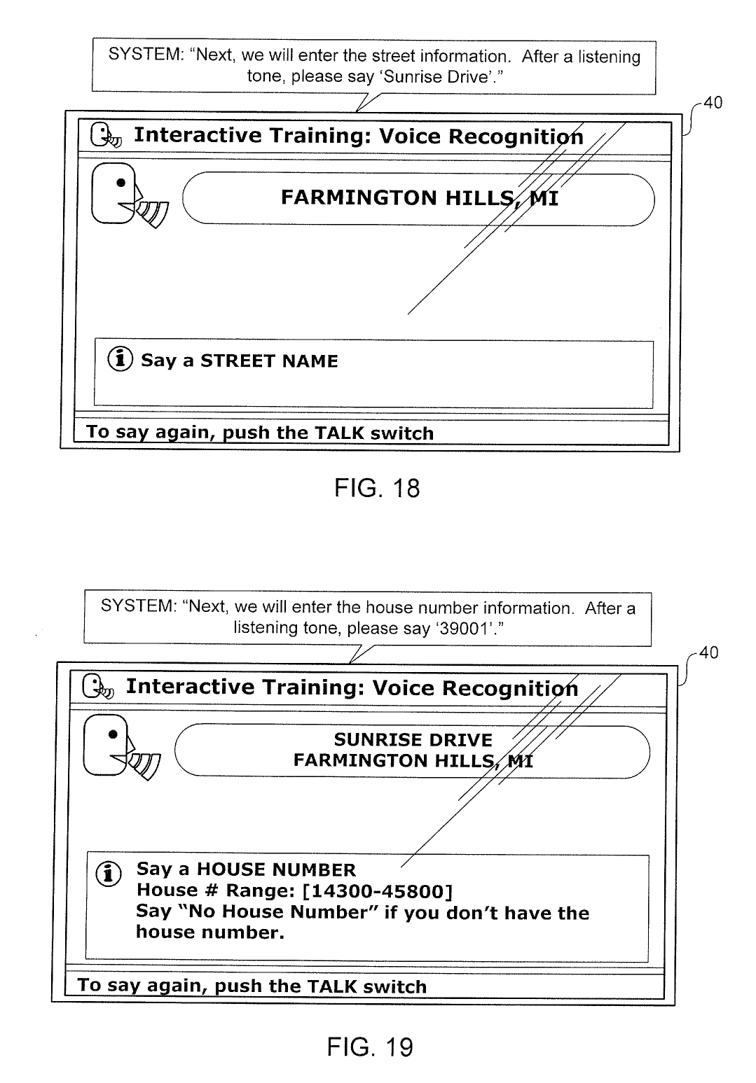

In step S120, the control unit 100 is configured to prompt the user to input the reference street name “Sunrise Drive” by issuing a voice prompt (e.g., “Next, we will enter the street information. After a listening tone, please say the street name ‘Sunrise Drive’.”). FIG. 18 is an example of the display screen and audio output for prompting the user to input the street name.

In step S130, the control unit 100 is configured to determine whether the street name inputted by the user through the microphone 30 matches the reference street name (“Sunrise Drive” in this example). If the control unit 100 determines that the user's input does not match the reference street name, then the control unit 100 returns to step S120 to ask the user to input the street name again. The control processing in steps S120 and S130 is repeated until the user's input matches the reference street name. On the other hand, if the control unit 100 determines that the user's input matches the reference street name, then the control unit 100 proceeds to step S140.

In step S140, the control unit 100 is configured to prompt the user to input the reference house number “39001” by issuing a voice prompt (e.g., “Next, we will enter the house number information. After a listening tone, please say the house number ‘39001’.”). FIG. 19 is an example of the display screen and audio output for prompting the user to input the house number.

In step S150, the control unit 100 is configured to determine whether the house number inputted by the user through the microphone 30 matches the reference house number (“39001” in this example). If the control unit 100 determines that the user's input does not match the reference house number, then the control unit 100 returns to step S140 to ask the user to input the house number again. The control processing in steps S140 and S150 is repeated until the user's input of the voice recognition command matches the reference house number. On the other hand, if the control unit 100 determines that the user's input matches the reference house number, then the control unit 100 proceeds to step S160.

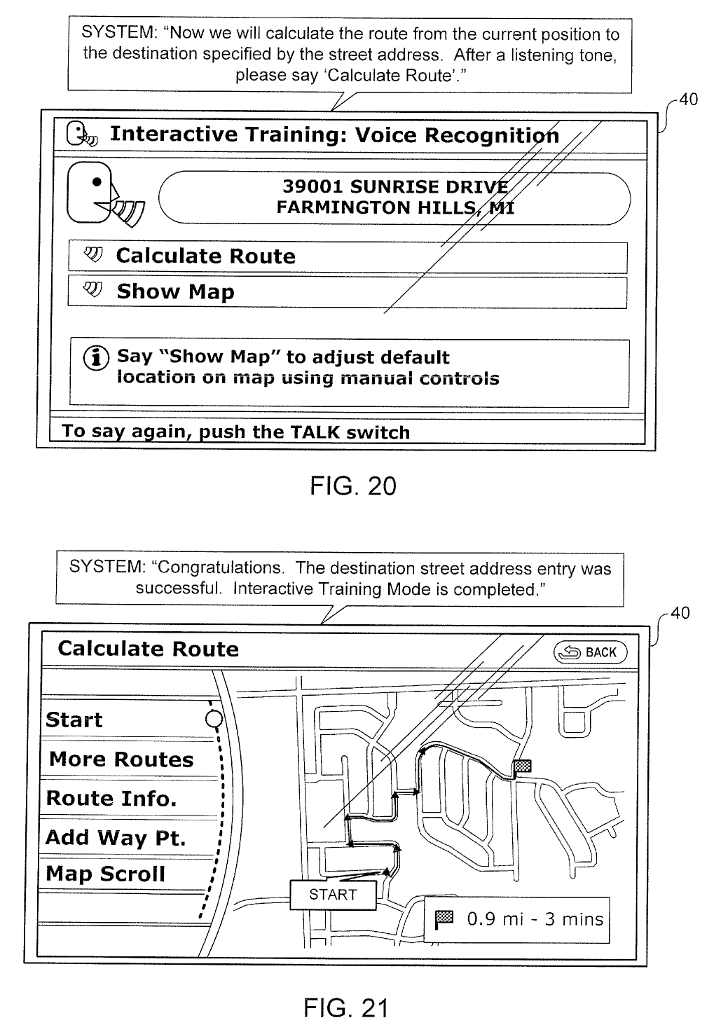

In step S160 the control unit 100 is configured to prompt the user to input a reference voice command “Calculate Route” by issuing a voice prompt (e.g., “Now we will calculate the route from the current position to the destination specified by the street address. After a listening tone, please say ‘Calculate Route’.”). FIG. 20 is an example of the display screen and audio output for prompting the user to input the voice command.

In step S170, the control unit 100 is configured to determine whether the voice command inputted by the user through the microphone 3 0 matches the reference voice command (“Calculate Route” in this example). If the control unit 100 determines that the user's input does not match the reference voice command, then the control unit 100 returns to step S160 to ask the user to input the voice command again. The control processing in steps S160 and S170 is repeated until the user's input of the voice command matches the reference voice command. On the other hand, if the control unit 100 determines that the user's input matches the reference voice command in step S170, then the control unit 100 proceeds to step S180.

In step S180, the control unit 100 is configured to calculate a route (or a plurality of routes) from a current position of the vehicle V to the destination address specified by the voice recognition entry (“39001 Sunrise Drive, Farmington Hills, Mich” in this example) and to display the calculated route or routes on the display device 40. The control unit 100 is also configured to inform the user that the interactive training mode is completed. FIG. 21 shows an example of the display screen and audio output for displaying the calculated route and informing the user that the interactive training mode is completed. Then, the control unit 100 ends the interactive tutorial control.

Accordingly, the vehicle on-board device of the illustrated embodiment, the user is provided with step-by-step interactive instructions on how to use the prescribed functions of the vehicle on-board device. The interactive step-by-step instructions can be performed by using the existing user interface device (e.g., the control panel 10, the steering switch unit 20, the microphone 30, the display device 40 and the audio speaker 50) provided in the vehicle V. Therefore, the vehicle on-board device according to the illustrated embodiment can guide the user to learn the various functions of the on-board device at the user's convenience. Providing such interactive learning system for the vehicle on-board device would significantly enhance the user's appreciation on complicated systems.

In the embodiment illustrated above, the control unit 100 is configured to repeat prompting the user to enter the user input (e.g., the operation of the multi function controller 11 and/or the audio input) upon determining that the user input does not match the prescribed (reference) user input in steps S30, S50, S70, S90, S10, S130, S150 and S170 of FIG. 7. Alternatively, when the user input does not match the prescribed user input in steps S30, S50, S70, S90, S110, S130, S150 and S170, the control unit 100 can be configured to wait until a subsequent user input matches the prescribed user input before proceeding to the next control step without repeatedly prompting the user to enter the user input.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle on-board device comprising:
a user interface device mounted inside of a vehicle, and configured and arranged to output information to a user and to receive a user input; and
a processing section operatively coupled to the user interface device, and configured to perform a prescribed function in response to a prescribed user operation received by the user input interface device,
the processing section being further configured to perform an interactive tutorial control to provide the user with at least one interactive instruction for the prescribed function in which the processing section
prompts the user to input the prescribed user operation,
determines whether the user input received by the user interface device matches the prescribed user operation, and
completes the interactive learning control when the user input matches the prescribed user operation.

2. The vehicle on-board device as recited in claim 1, wherein
the processing section is further configured to repeat prompting the user to input the prescribed operation when the user input does not match the prescribed user operation.

3. The vehicle on-board device as recited in claim 1, wherein
the processing section is further configured to wait until the user input matches the prescribed user operation before completing the interactive learning control when the user input does not match the prescribed user operation.

4. The vehicle on-board device as recited in claim 1, wherein
the processing section is configured to perform the prescribed function in response to the prescribed user operation including a first user input and a second user input sequentially received by the user input interface device,
the processing section is further configured to perform the interactive tutorial control in which the processing section
prompts the user to input the first user input,
determines whether the user input received by the user interface device matches the first user input,
prompts the user to input the second user input when the user input matches the first user operation,
determines whether the user input received by the user interface device matches the second user input, and
completes the interactive learning control when the user input matches the second user operation.

5. The vehicle on-board device as recited in claim 4, wherein
the processing section is further configured to repeat prompting the user to input the first user input upon determining that the user input does not match the first user input, and to repeat prompting the user to input the second user input upon determining that the user input does not match the second user input.

6. The vehicle on-board device as recited in claim 4, wherein
the processing section is further configured to wait until the user input matches the first user input before prompting the user to input the second user input when the user input does not match the first user input, and to wait until the user input matches the second user input before completing the interactive learning control when the user input does not match the second user input.

7. The vehicle on-board device as recited in claim 1, wherein
the user interface device is configured and arranged to output an audio sound and to receive an audio input by the user, and
the processing section is further configured to perform a voice recognition entry to operate the vehicle on-board device as the prescribed function upon the user entering a prescribed audio command as the audio input.

8. The vehicle on-board device as recited in claim 7, wherein
the processing section is further configured to output a reference audio command corresponding to the prescribed audio command to prompt the user to input the prescribed audio command.

9. The vehicle on-board device as recited in claim 7, wherein
the processing section is further configured to convert the audio input to a machine readable input and to compare the machine readable input with a reference value corresponding to the prescribed audio command to perform the voice recognition entry.

10. The vehicle on-board device as recited in claim 1, wherein
the processing section is further configured to operate a vehicle component as the prescribed function.

11. The vehicle on-board device as recited in claim 1, wherein
the processing section is further configured to perform a navigation control as the prescribed function.

12. The vehicle on-board device as recited in claim 1, wherein
the processing section is further configured to perform a display control as the prescribed function.

13. The vehicle on-board device as recited in claim 1, wherein
the processing section is further configured to perform an audio control as the prescribed function.

14. The vehicle on-board device as recited in claim 1, wherein
the processing section is further configured to perform a climate control as the prescribed function.

15. The vehicle on-board device as recited in claim 1, wherein
the processing section is further configured to perform a control of a mobile device connected to the vehicle on-board device via a wireless network as the prescribed function.

16. The vehicle on-board device as recited in claim 1, wherein
the user interface device includes a display section and at least one input button, and
the processing section is further configured to display a position of the input button on the display section for the user, and then to prompt the user to locate the input button in the display section in the interactive tutorial control.
